(19) United States
(12) Patent Application Publication
(10) Pub. No.: US 2017/0259830 A1
(43) Pub. Date: Sep. 14, 2017

(54) MOVING AMOUNT DERIVATION APPARATUS

(71) Applicant: FUJITSU TEN LIMITED, Kobe-shi (JP)

(72) Inventors: Atsushi MINO, Kobe-shi (JP); Yuuki MATSUMOTO, Kobe-shi (JP); Naoshi KAKITA, Kobe-shi (JP)

(73) Assignee: FUJITSU TEN LIMITED, Kobe-shi (JP)

(21) Appl. No.: 15/609,413

(22) Filed: May 31, 2017

Related U.S. Application Data
(62) Division of application No. 14/660,652, filed on Mar. 17, 2015.

(30) Foreign Application Priority Data
Mar. 25, 2014 (JP) 2014-061656

(51) Int. Cl. B60W 50/08; B60K 35/00; B60K 37/06

(52) U.S. Cl. CPC B60W 50/08; B60K 37/06; B60K 2350/1028; B60K 35/00

(57) ABSTRACT

A moving amount derivation apparatus derives a moving amount of a host apparatus that includes the moving amount derivation apparatus. The moving amount derivation apparatus includes: an image acquisition part that acquires a series of photographic images from a photographing apparatus that the host apparatus includes and that moves with the host apparatus; and an image processor coupled to the image acquisition part. The image processor is configured to: (i) derive a moving vector of a photographed object within the series of the photographic images, using a plurality of the photographic images out of the series of the photographic images, the plurality of the photographic images having been photographed at different time points; and (ii) derive the moving amount of the host apparatus based on the moving vector.

This is a Divisional of U.S. patent application Ser. No. 14/660,652 filed Mar. 17, 2015, the entire contents of which is incorporated herein by reference.

### BACKGROUND OF THE INVENTION

Field of the Invention

The invention relates to the technology for deriving a moving amount of a vehicle.

Description of the Background Art

Conventionally, an amount by which a vehicle has moved (hereinafter referred to as “moving amount”) is derived and various types of vehicle control of the vehicle are performed based on the derived moving amount. For example, as an example of parking assistance, a moving path that a host vehicle will take is estimated based on the derived moving amount and the moving path is superimposed, as a guiding line, in an image photographed by a back camera. Moreover, as different park assistance, a solid object in an image photographed by a camera is detected, by using the moving amount of the host vehicle. Such a moving amount of the host vehicle is derived based on information acquired by one or more sensors, such as a vehicle speed sensor and a steering wheel angle sensor.

However, the conventional technology mentioned above needs to install a vehicle speed sensor, a steering wheel angle sensor and/or the like specialized in derivation of the moving amount of the host vehicle. That leads to an increase in costs and to a space for installation of the sensor(s). Therefore, it is difficult to realize miniaturization and cost reduction.

### SUMMARY OF THE INVENTION

According to one aspect of the invention, a moving amount derivation apparatus derives a moving amount of a host apparatus that includes the moving amount derivation apparatus. The moving amount derivation apparatus includes: an image acquisition part that acquires a series of photographic images from a photographing apparatus that the host apparatus includes and that moves with the host apparatus; and an image processor coupled to the image acquisition part. The image processor is configured to: (i) derive a moving vector of a photographed object within the series of the photographic images, using a plurality of the photographic images out of the series of the photographic images, the plurality of the photographic images having been photographed at different time points; and (ii) derive the moving amount of the host apparatus based on the moving vector.

Since the moving amount is derived based on the moving vector derived by use of the plurality of photographic images, the moving amount can be derived without installation of a sensor only for deriving the moving amount.

According to another aspect of the invention, the image processor is further configured to: generate a bird's-eye view image corresponding to any of the acquired photographic images; and derive the moving vector based on the bird's-eye view images corresponding to the plurality of the photographic images photographed at the different time points.

Since the moving vector is derived based on the bird's-eye view images corresponding to the plurality of photographic images, the moving vector having a magnitude close to a moving amount in a real space can be derived.

Therefore, an object of the invention is to provide a technology for deriving a moving amount of a host vehicle without installation of a sensor only for deriving the moving amount.

These and other objects, features, aspects and advantages of the invention will become more apparent from the following detailed description of the invention when taken in conjunction with the accompanying drawings.

### BRIEF DESCRIPTION OF THE DRAWINGS

FIG. 1 illustrates a block diagram of a moving amount derivation system;

FIG. 2 illustrates a photographing direction of a camera;

FIG. 3 illustrates a case where the moving amount derivation system is used;

FIG. 4 illustrates a photographic image showing a region behind a host vehicle;

FIG. 5 illustrates a flowchart showing a process performed by the moving amount derivation system;

FIG. 6A illustrates a photographic image;

FIG. 6B illustrates a bird's-eye view image;

FIG. 7A illustrates a photographic image;

FIG. 7B illustrates a bird's-eye view image;

FIG. 8A illustrates a method of deriving moving vectors;

FIG. 8B illustrates the method of deriving moving vectors;

FIG. 9 illustrates a histogram for moving vectors;

FIG. 10 illustrates a block diagram of a moving amount derivation system;

FIG. 11 illustrates a flowchart showing a process performed by the moving amount derivation system;

FIG. 12A illustrates a method of deriving moving vectors;

FIG. 12B illustrates the method of deriving moving vectors;

FIG. 13 illustrates a method of deriving moving vectors;

FIG. 14 illustrates the method of deriving moving vectors;

FIG. 15 illustrates a histogram for moving vectors;

FIG. 16A illustrates a histogram for moving vectors; and

FIG. 16B illustrates a histogram for moving vectors.

### DESCRIPTION OF THE EMBODIMENTS

### Embodiment for Carrying Out the Invention

Hereinafter, some embodiments of the invention are described with reference to the drawings.

### 1. First Embodiment

<1-1. System Configuration>

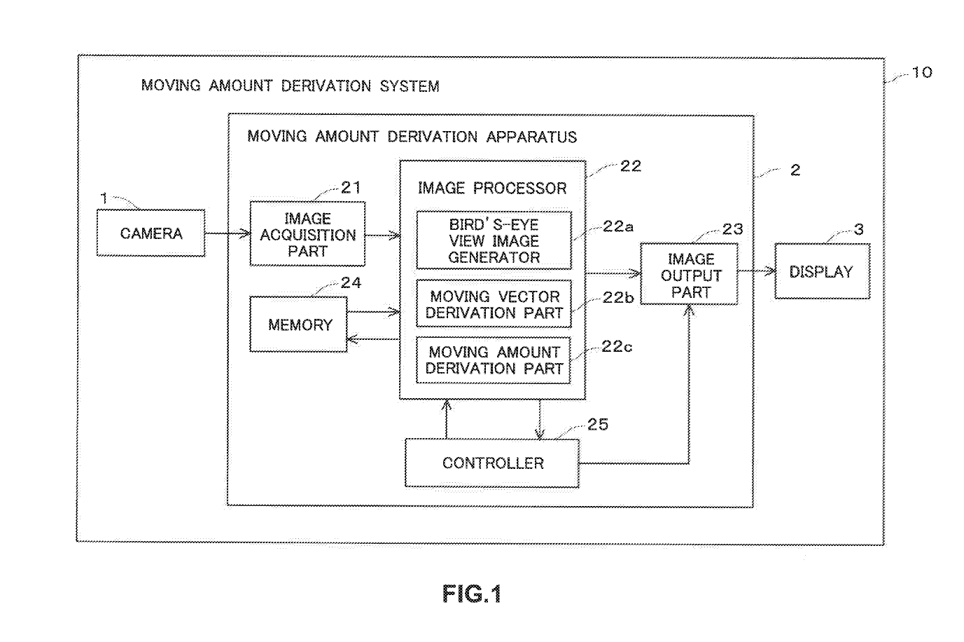

First explained is a configuration of a moving amount derivation system 10 in this embodiment. FIG. 1 illustrates a schematic block diagram showing the configuration of the moving amount derivation system 10. The moving amount derivation system 10 includes a camera 1, a moving amount derivation apparatus 2 and a display 3. The moving amount derivation system 10 is mounted on a vehicle, such as a car, and includes a function of deriving a moving amount of the vehicle. The moving amount derivation system 10 may have a function, for example, of displaying a guiding line as parking assistance based on the derived moving amount. Hereinafter, a vehicle on which the moving amount derivation system 10 is mounted is referred to as “host vehicle.”

The camera 1 acquires a photographic image by photographing a region near the host vehicle. The camera 1 includes a lens and an imaging device and electronically acquires the photographic image. The camera 1 acquires the photographic images repeatedly in a predetermined cycle (e.g., a cycle of 1/30 second). The camera 1 is disposed, for example, on a rear portion of the host vehicle, to be used as a back camera that photographs a region behind the host vehicle. However, the embodiment is not limited to the configuration that uses this camera but may have a configuration that uses a camera for photographing a region in a different direction or that uses plural cameras.

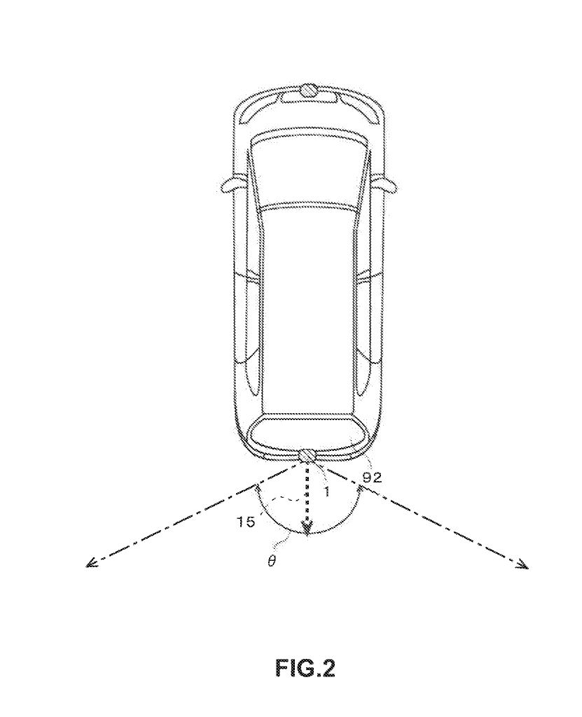

FIG. 2 illustrates a photographing direction of the camera 1 used as the back camera. As shown in FIG. 2, the camera 1 is disposed on a back door 92 that is a rear end of the host vehicle, having an optical axis 15 extending backward in a front-back direction of the host vehicle. Thus, the camera 1 photographs the region behind the host vehicle to acquire the photographic images showing a situation of the region behind the host vehicle. Moreover, a fisheye lens is used for the lens of the camera 1, and the camera 1 has an angle of view of substantially 135 degrees. Therefore, the camera 1 photographs the region behind the host vehicle at substantially 135 degrees in a right-left direction.

The moving amount derivation system 10 derives a moving amount of the host vehicle, using the photographic images acquired by the camera 1. Then, the moving amount derivation system 10 estimates a path that the host vehicle will take in the future (hereinafter referred to as “future moving path”), using the derived moving amount and moving amounts derived in the past, and causes the display 3 to display an image generated by superimposing the future moving path as a guiding line on the photographic image. Thus, a user can easily understand the path that the host vehicle will take.

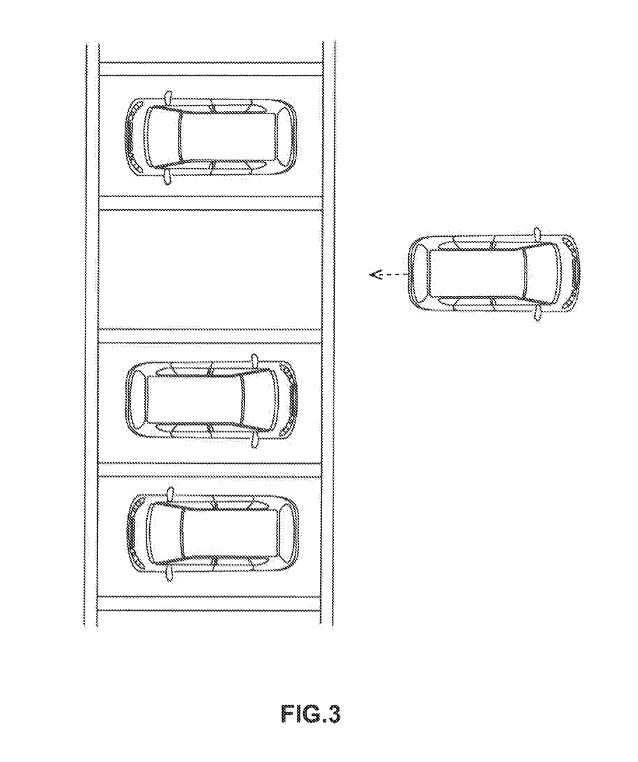

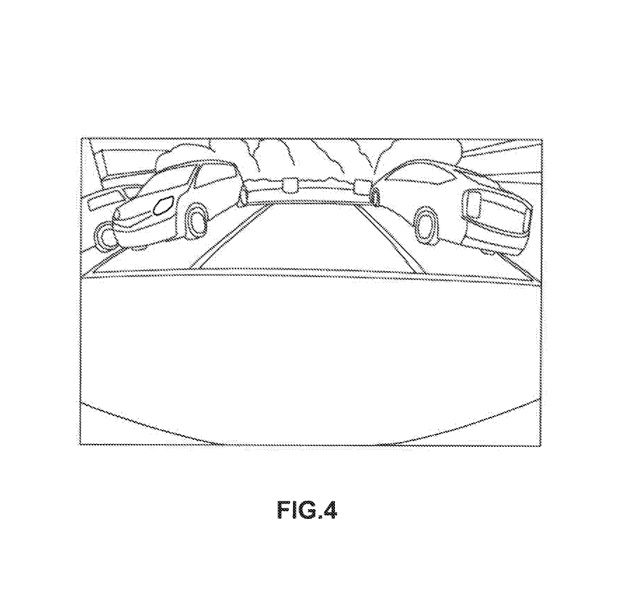

FIG. 3 illustrates an example case where the moving amount derivation system 10 is used. FIG. 3 illustrates a case where the host vehicle is being parked in a parking lot. FIG. 3 illustrates the host vehicle in a process of parking in the parking lot. FIG. 4 illustrates an example of the photographic image showing the region behind the host vehicle photographed by the camera 1 in the process of parking.

With reference back to FIG. 1, the moving amount derivation apparatus 2 derives the moving amount of the host vehicle based on the photographic image photographed by the camera 1. The moving amount derivation apparatus 2 includes an image acquisition part 21, an image processor 22, an image output part 23, a memory 24 and a controller 25.

The image acquisition part 21 temporally continuously acquires analog or digital photographic images from the camera 1 in a predetermined cycle (e.g., a cycle of 1/30 second). In a case where analog photographic images are obtained, the image acquisition part 21 converts the analog photographic images into digital photographic images (A/D conversion). One of the photographic images processed by the image acquisition part 21 is used as one frame of a video signal.

The image processor 22 performs a predetermined process of the photographic image acquired by the image acquisition part 21. The image processor 22 may use a hardware circuit, such as ASIC and FPGA, that is able to perform such a predetermined process. The image processor 22 includes a bird's-eye view image generator 22a, a moving vector derivation part 22b and a moving amount derivation part 22c.

The bird's-eye view image generator 22a includes a function of generating a bird's-eye view image based on the photographic image acquired by the image acquisition part 21. For example, the bird's-eye view image generator 22a changes and re-draws the photographic image photographed from a position of a viewpoint the camera 1 and then acquired by the image acquisition part 21, to a photographic image viewed from above the host vehicle, and generates the bird's-eye view image. The bird's-eye view image generated by the bird's-eye view image generator 22a is stored in the memory 24.

The moving vector derivation part 22b includes a function of deriving a moving vector of the host vehicle, using the bird's-eye view image generated by the bird's-eye view image generator 22a. For example, the moving vector derivation part 22b extracts a portion showing a same object from each of the bird's-eye view images generated based on temporally continuous photographic images, and then derives moving vectors based on a positional relationship of the extracted portions in the bird's-eye view images.

The moving amount derivation part 22c includes the function of deriving a moving amount of the host vehicle, using the moving vectors derived by the moving vector derivation part 22b. The moving vectors derived by the moving vector derivation part 22b include moving vectors of a road surface and moving vectors of a solid object. Each of the moving vectors of the road surface represents a magnitude and a direction by/in which a portion showing the road surface has moved between the bird's-eye view images. Since the moving amount of the host vehicle corresponds to the moving vectors of the road surface, the moving amount derivation part 22c extracts the moving vectors of the road surface from the derived moving vectors, and derives the moving amount of the host vehicle based on the moving vectors of the road surface.

A bird's-eye view image generation process performed by the bird's-eye view image generator 22a, a moving vector derivation process performed by the moving vector derivation part 22b, and a moving amount derivation process performed by the moving amount derivation part 22c are explained later in detail.

The image output part 23 generates a display image by including information relating to results of different processes performed by use of the derived moving amount into the photographic image. Then the image output part 23 converts the generated display image into a video signal in a predetermined format, such as NTSC, and outputs the converted video signal to the display 3. For example, in a case where the future moving path is estimated by use of the moving amount, the display image is generated by superimposing a guiding line showing the estimated moving path on the photographic image and the generated display image is output to the display 3. Thus, the display image including the photographic image is displayed on the display 3.

The memory 24 stores the bird's-eye view images generated by the bird's-eye view image generator 22a. In this embodiment, the moving vector derivation part 22b derives the moving vectors, using the plural bird's-eye view images acquired at temporally different photographing timings. Thus, the memory 24 stores the bird's-eye view images acquired in the past in addition to a latest bird's-eye view image. In other words, the memory 24 stores the bird's-eye view images required for derivation of the moving vectors. Examples of the memory 24 are a volatile semiconductor memory and a nonvolatile semiconductor memory. However, another storage medium, for example, a hard disk drive including a magnetic disk, may be used.

The controller 25 is, for example, a microcomputer including a CPU, a RAM, a ROM and the like, and controls various parts, including the image processor 22, of the moving amount derivation apparatus 2. Various functions of the controller 25 are implemented by software. In other words, the functions of the controller 25 are performed by arithmetic processing of the CPU based on programs (execution of the programs) stored in the ROM or the like.

The display 3 is disposed in a position where a user (a driver in many cases) in a vehicle cabin of the host vehicle can see the display 3 and informs the user of various kinds of information. The display 3 may include a navigation function of providing a route guidance leading to a destination or a touch panel function of receiving a user operation.

<1-2. Process Performed by System>

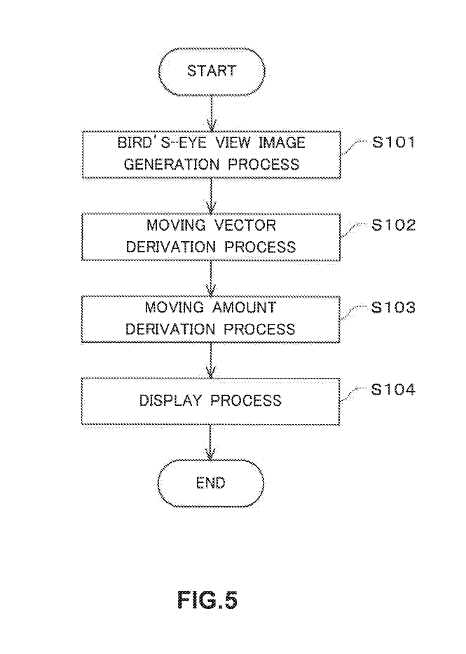

Next explained is a process performed by the moving amount derivation system 10. FIG. 5 illustrates a flowchart showing the process performed by the moving amount derivation system 10.

In a case where a predetermined condition is satisfied, the image acquisition part 21 of the moving amount derivation system 10 acquires the photographic image photographed by the camera 1 and outputs the acquired photographic image to the image processor 22. Examples of the predetermined condition are a case where a command to start the process is input and a case where a shift lever of the host vehicle is moved to R (reverse). Then, the image processor 22 performs the bird's-eye view image generation process (a step S101).

Concretely, first, the bird's-eye view image generator 22a acquires data of the photographic image from the image acquisition part 21. Since the photographic image is photographed from the viewpoint located in a direction of the optical axis of the camera 1, the bird's-eye view image generator 22a changes the viewpoint and then generates the bird's-eye view image viewed from above the host vehicle. A well-known method may be used to generate the bird's-eye view image based on the photographic image acquired by the camera 1.

The bird's-eye view image generator 22a generates the bird's-eye view images corresponding to the photographic images acquired by the image acquisition part 21. In other words, the bird's-eye view image generator 22a generates the bird's-eye view image based on the photographic image for each frame. Then the bird's-eye view image generator 22a stores the generated bird's-eye view images in the memory 24.

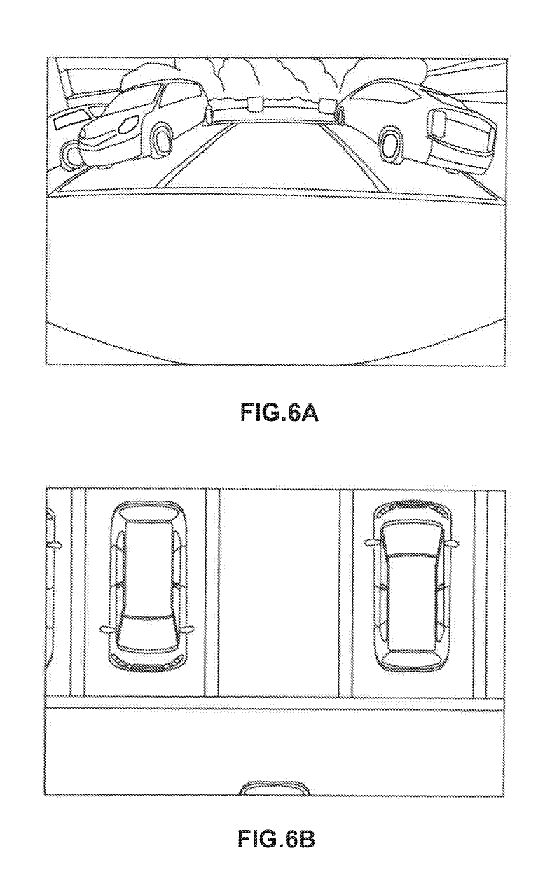

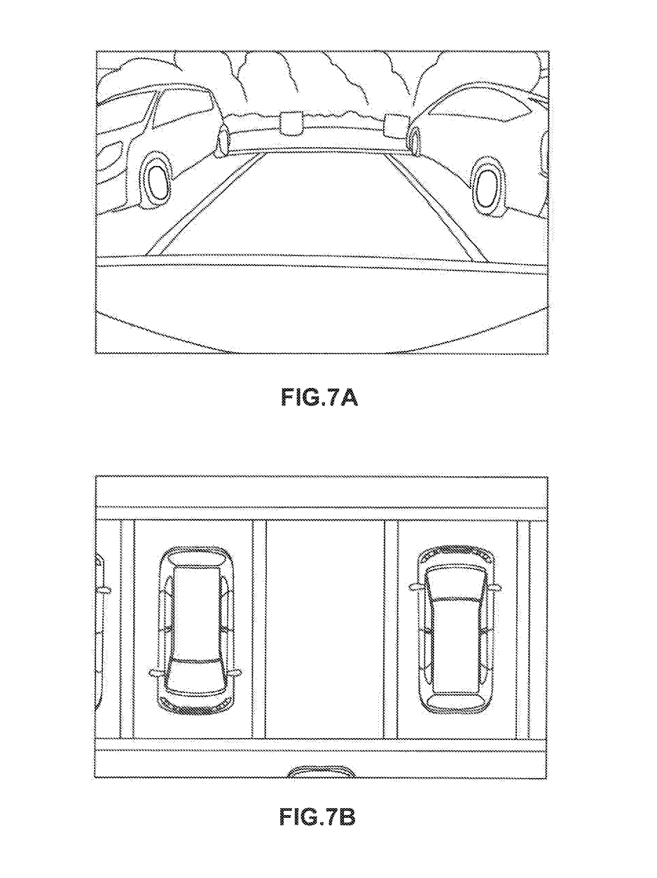

Here, the process is explained with reference to the drawings. FIGS. 6A, 6B, 7A and 7B illustrate the photographic images photographed at temporally different photographing timings and the bird's-eye view images based on those photographic images. FIGS. 6A and 7A illustrate the photographic images acquired by the camera 1 and FIGS. 6B and 7B illustrate the bird's-eye view images generated based on those photographic images. Once acquiring the photographic image as shown in FIG. 6A from the image acquisition part 21, the bird's-eye view image generator 22a changes the viewpoint of the photographic image and generates the bird's-eye view image as shown in FIG. 6B. Moreover, once acquiring the photographic image as shown in FIG. 7A from the image acquisition part 21, the bird's-eye view image generator 22a changes the viewpoint of the photographic image and generates the bird's-eye view image as shown in FIG. 7B. As described above, the bird's-eye view image generator 22a generates the bird's-eye view image for each photographic image per frame.

With reference back to FIG. 5, next, the image processor 22 performs the moving vector derivation process (a step S102). The moving vector derivation process is a process in which the moving vector derivation part 22b derives the moving vectors, using the bird's-eye view images generated by the bird's-eye view image generator 22a.

Concretely, the moving vector derivation part 22b acquires a bird's-eye view image of a current frame generated by the bird's-eye view image generator 22a and at a same time acquires a bird's-eye view image of a previous frame stored in the memory 24. The moving vector derivation part 22b compares these bird's-eye view images of the temporally continuous frames and extracts picture elements showing a same object from those bird's-eye view images. Then, the moving vector derivation part 22b derives the moving vectors by connecting positions (coordinates) of the picture elements extracted from the previous frame with positions (coordinates) of the picture elements extracted from a subsequent frame (the current frame). In other words, each of the moving vectors is a vector derived by connecting a position of an object in a bird's-eye view image photographed before moving with a position of the object in a bird's-eye view image photographed after moving.

Template matching, for example, may be used as a method of extracting picture elements of a same object. The template matching is a technique for finding a portion of an image that matches a template image specified beforehand. In a case where the template matching is used in this embodiment, for example, a process is performed in which a portion of the bird's-eye view image of the subsequent frame is compared with a same portion of the bird's-eye view image of the previous frame set as a template image. Then, the process is repeated for other portions of the bird's-eye view image until the entire bird's-eye view image is compared. The sum of absolute difference (SAD), the sum of squared difference (SSD) and the like may be used as the template matching technique as described above.

Besides the template matching technique, a feature point matching method may be used. The feature point matching method is a method that uses the so-called optical flow. In other words, the feature point matching method extracts feature points from the plural bird's-eye view images generated based on the plural photographic images acquired at different time points and derives optical flows representing movements of the feature points between or among the plural photographic images. The feature points are outstanding points for detection, for example, a point of a corner of an object (an intersection point of an edge). Then, the feature point matching method associates feature points extracted from a latest bird's-eye view image with feature points extracted from a past bird's-eye view image and then derives moving vectors based on positions of the associated feature points.

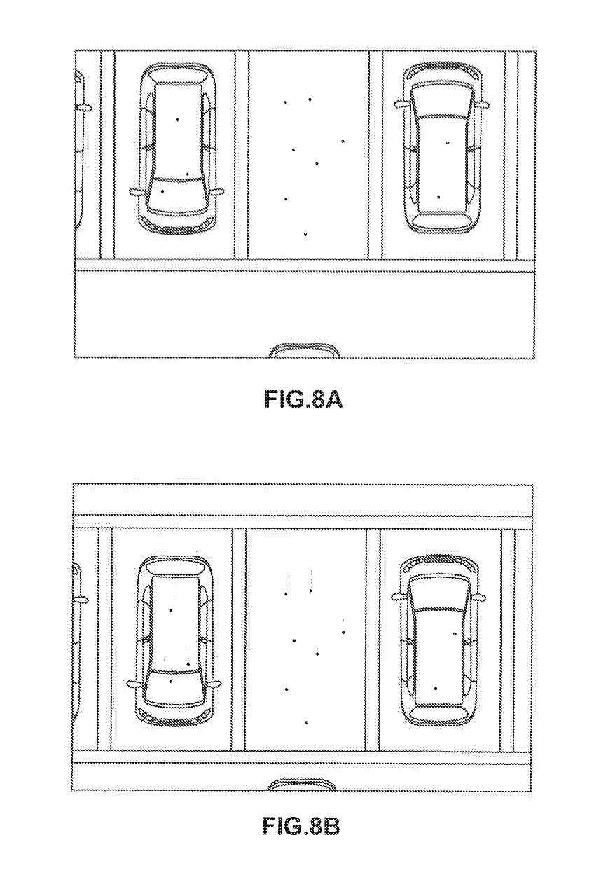

A method of deriving the moving vectors is explained with reference to the drawings. FIGS. 8A and 8B illustrate the method of deriving the moving vectors by use of the feature point matching method. FIGS. 8A and 8B illustrate the bird's-eye view image of the previous frame and the bird's-eye view image of the subsequent frame, respectively. FIGS. 8A and 8B are the same as FIGS. 6B and 7B, respectively, generated based on the photographic images shown in FIGS. 6A and 7A.

As shown in FIGS. 8A and 8B, feature points (dots), as examples, are shown in the bird's-eye view images of the previous frame and the subsequent frame. FIG. 8B also shows paths on which the feature points have moved from positions in the previous frame to positions in the subsequent frame. The moving vector derivation part 22b derives moving directions and moving magnitudes of those feature points as moving vectors.

With reference back to FIG. 5, next, the image processor 22 performs the moving amount derivation process (a step S103). The moving amount derivation process is a process in which the moving amount derivation part 22c derives an actual moving amount of the host vehicle, using the moving vectors derived by the moving vector derivation part 22b.

In many cases, the photographic image of the region near the host vehicle photographed by the camera 1 includes the portion showing the road surface and a portion showing a cubic object, such as a vehicle. Since the road surface is a plane and is not a moving object, moving vectors of the road surface have substantially a same magnitude in substantially a same direction. On the other hand, moving vectors of the cubic objects have different magnitudes in different directions, depending on moving directions and heights of the cubic objects.

Therefore, the moving vectors of the cubic objects do not represent an accurate moving amount of the host vehicle, but the moving vectors of the road surface represent the accurate moving amount of the host vehicle. The moving vectors derived by the moving vector derivation part 22b include the moving vectors having different magnitudes in different directions. Therefore, the moving vectors of the road surface need to be extracted from the moving vectors derived by the moving vector derivation part 22b to accurately derive the moving amount of the host vehicle.

Generally, the portions showing the road surface account for most of the photographic image showing the region near the host vehicle. Therefore, the moving vectors of the road surface account for most of the moving vectors derived by the moving vector derivation part 22b. In this embodiment, a histogram of magnitudes for all of the extracted moving vectors is generated and the moving vectors categorized in a range having a largest number of the moving vectors (peak in the histogram) are extracted as the moving vectors of the road surface. Then, the moving amount derivation part 22c derives a magnitude of the extracted moving vectors of the road surface as the moving amount of the host vehicle.

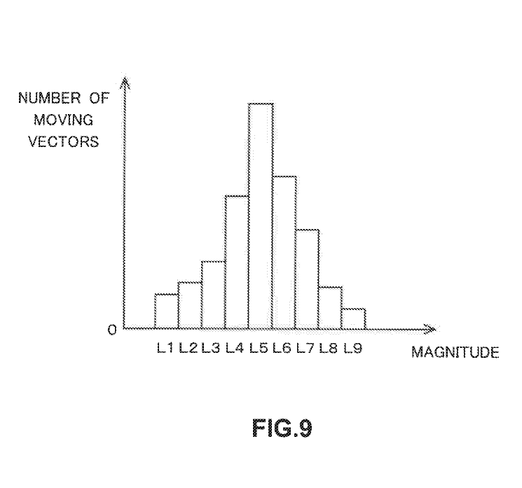

Here, the process is explained concretely with reference to the drawing. FIG. 9 illustrates an example of the histogram of magnitudes for all of the extracted moving vectors. FIG. 9 illustrates the histogram showing all of the extracted moving vectors categorized and accumulated in nine length ranges from L1 to L9, depending on a length of the moving vector. As shown in FIG. 9, number of the moving vectors in the length range L5 is the largest. Therefore, the moving amount derivation part 22c determines that the moving vectors of the road surface are included in the length range L5. In other words, the moving amount derivation part 22c extracts the moving vectors of the road surface.

Then, the moving amount derivation part 22c derives the magnitude of the extracted moving vectors of the road surface as the moving amount of the host vehicle. In other words, in a case of FIG. 9, the length range L5 is derived as the moving amount of the host vehicle.

With reference back to FIG. 5, next, the moving amount derivation system 10 performs a predetermined display process, using the derived moving amount of the host vehicle (a step S104). The moving amount derivation system 10 performs the display process, for example, of showing the guiding line as the future moving path. In this case, the controller 25 estimates the future moving path of the host vehicle based on the moving amount derived by the moving amount derivation part 22c. The controller 25 estimates the future moving path based on the moving amount derived from the bird's-eye view images of the plural frames.

Next, the image output part 23 generates the display image by superimposing the guiding line showing the estimated future moving path of the host vehicle on the photographic image, and outputs the generated display image to the display 3. Then the display 3 inputs the display image and displays the input display image. In this manner, the predetermined display process is performed.

As described above, in this embodiment, the photographic image photographed by the camera 1 is converted into the bird's-eye view image and the moving vectors of the road surface are derived and thus the moving amount of the host vehicle is derived. Moreover, it is possible to derive the moving amount by use of the camera that is mounted for another purpose, without installation of a sensor only for deriving the moving amount. Thus, miniaturization and cost reduction can be realized. Further, since the moving vectors of the road surface are extracted from the derived moving vectors, the moving amount can be derived accurately.

### 2. Second Embodiment

Next, a second embodiment is described. The first embodiment explains the configuration in which the moving vectors of the road surface are derived by use of the plural bird's-eye view images generated based on the photographic images photographed at the different time points. However, the invention is not limited to the configuration. For example, a configuration may be possible in which moving vectors of a road surface are derived by projecting, onto a road surface, moving vectors derived on an image by use of a photographic image photographed by a camera. The configuration is explained in the second embodiment.

In the first embodiment, the bird's-eye view image needs to be generated based on the photographic image for each frame in order to derive the moving vectors of the road surface. On the other hand, in the second embodiment, the moving vectors of the road surface can be derived without generation of the bird's-eye view image based on the photographic image. Therefore, process load can be reduced.

Moreover, since quality of the bird's-eye view image is deteriorated through the process of generating the bird's-eye view image based on the photographic image, in some cases, derivation accuracy of the moving vectors is lowered. In the second embodiment, since there is no need to convert the photographic image into the bird's-eye view image, it is possible to prevent the derivation accuracy of the moving vectors from being lowered. Hereinafter, the second embodiment is concretely described.

<2-1. System Configuration>

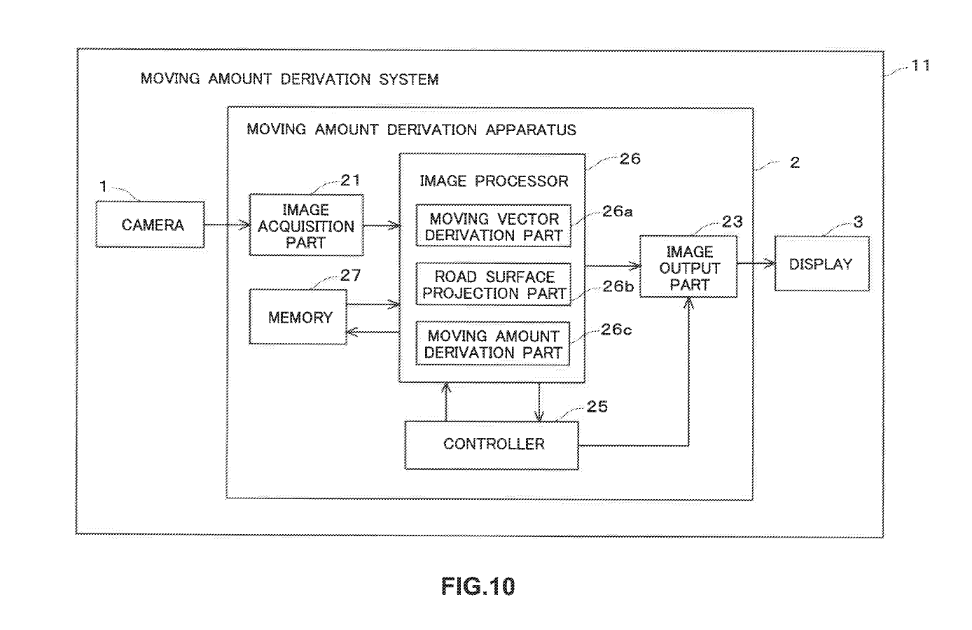

First explained is a configuration of a moving amount derivation system 11 in the second embodiment. FIG. 10 illustrates a schematic block diagram showing the configuration of the moving amount derivation system 11. The moving amount derivation system 11 includes a camera 1, a moving amount derivation apparatus 2 and a display 3. The moving amount derivation system 11 is mounted on a vehicle, such as a car, and includes a function of deriving a moving amount of the vehicle. The moving amount derivation system 11 may have a function, for example, of displaying a guiding line as parking assistance based on the derived moving amount. Hereinafter, a vehicle on which the moving amount derivation system 11 is mounted is referred to as “host vehicle.”

The camera 1 acquires a photographic image by photographing a region near the host vehicle and a configuration of the camera 1 in the second embodiment is substantially the same as the configuration of the camera 1 in the first embodiment. Moreover, like in the first embodiment, the moving amount derivation system 11 derives the moving amount of the host vehicle, using the photographic images acquired by the camera 1 and uses the derived moving amount.

The moving amount derivation apparatus 2 derives the moving amount of the host vehicle based on the photographic image photographed by the camera 1. The moving amount derivation apparatus 2 includes an image acquisition part 21, an image output part 23, a controller 25, an image processor 26 and a memory 27.

Configurations of the image acquisition part 21, the image output part 23 and the controller 25 in the second embodiment are substantially the same as the configurations of the image acquisition part 21, the image output part 23 and the controller 25 in the first embodiment. Therefore, in this embodiment, explanation of those configurations is omitted. Configurations of the image processor 26 and the memory 27 are explained.

The image processor 26 performs a predetermined process of the photographic image acquired by the image acquisition part 21. The image processor 26 may use a hardware circuit, such as ASIC and FPGA, that is able to perform such a predetermined process. The image processor 26 includes a moving vector derivation part 26a, an on-road-surface projection part 26b and a moving amount derivation part 26c.

The moving vector derivation part 26a includes a function of deriving moving vectors, using the photographic image acquired by the image acquisition part 21. For example, the moving vector derivation part 26a extracts a portion showing a same object from each of the plural photographic images photographed at different time points, and then derives the moving vectors based on positional relationship of the extracted portions in the plural photographic images.

The on-road-surface projection part 26b includes a function of projecting onto a road surface (in the world coordinate system) the moving vectors derived by the moving vector derivation part 26a and of deriving moving vectors on the road surface. Each of the moving vectors derived by the moving vector derivation part 26a shows a variation (i.e. moving amount) between the photographic images. Thus, the on-road-surface projection part 26b projects, onto the road surface, the moving vectors derived by the moving vector derivation part 26a, and thus the moving vectors on the road surface (hereinafter referred to as “on-road-surface moving vector(s)”) are derived and the derived on-road-surface moving vectors are converted into an actual moving amount. Here, the term “on-road-surface moving vectors” refers to as vectors generated by projecting the moving vectors on an image onto a road surface and includes moving vectors of the road surface and moving vectors of a cubic object.

The moving amount derivation part 26c includes the function of deriving the moving amount of the host vehicle, using the on-road-surface moving vectors derived by the on-road-surface projection part 26b. As described above, the on-road-surface moving vectors derived by the on-road-surface projection part 26b include the moving vectors of the road surface and the moving vectors of a cubic object. Since the moving amount of the host vehicle corresponds to the moving vectors of the road surface, the moving amount derivation part 26c extracts the moving vectors of the road surface from the on-road-surface moving vectors and derives the moving amount of the host vehicle based on the extracted moving vectors of the road surface.

A moving vector derivation process performed by the moving vector derivation part 26a, a projection process of the moving vectors onto the road surface (hereinafter also referred to as “on-road-surface projection process”) performed by the on-road-surface projection part 26b, and a moving amount derivation process performed by the moving amount derivation part 26c will be described later.

The memory 27 stores the photographic images photographed by the camera 1. In the second embodiment, the moving vector derivation part 26a derives the moving vectors, using the plural photographic images photographed at different time points. Thus, the memory 27 stores the photographic images acquired in the past in addition to a latest photographic image. In other words, the memory 27 stores the photographic images required for derivation of the moving vectors. Examples of the memory 27 are a volatile semiconductor memory and a nonvolatile semiconductor memory. However, another storage medium, for example, a hard disk drive including a magnetic disk, may be used.

The display 3 is disposed in a position where a user (a driver in many cases) in a vehicle cabin of the host vehicle can see the display 3 and informs the user of various kinds of information. The display 3 in the second embodiment has substantially the same configuration as the configuration of the display 3 in the first embodiment.

<2-2. Process Performed by System>

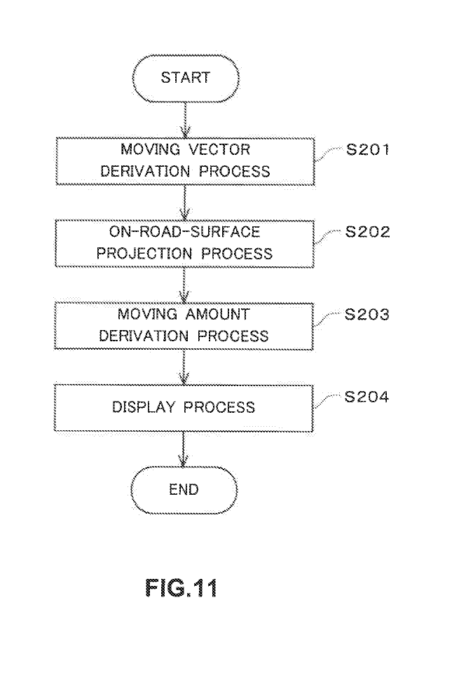

Next explained is a process performed by the moving amount derivation system 11. FIG. 11 illustrates a flowchart showing the process performed by the moving amount derivation system 11.

In a case where a predetermined condition is satisfied, the image acquisition part 21 of the moving amount derivation system 11 acquires the photographic image photographed by the camera 1 and outputs the acquired photographic image to the image processor 26. Examples of the predetermined condition are a case where a command to start the process is input and a case where a shift lever of the host vehicle is moved to R (reverse). Then, the image processor 26 performs the moving vector derivation process (a step S201). The moving vector derivation process is a process in which the moving vector derivation part 26a derives the moving vectors, using the photographic images.

Concretely, the moving vector derivation part 26a acquires a photographic image of a current frame acquired by the image acquisition part 21 and at a same time acquires a photographic image of a previous frame stored in the memory 27. The moving vector derivation part 26a compares these photographic images of the temporally continuous frames and extracts picture elements showing a same object from those photographic images. Then, the moving vector derivation part 26a derives the moving vectors by connecting positions (coordinates) of the picture elements extracted from the previous frame with positions (coordinates) of the picture elements extracted from a subsequent frame (the current frame). In other words, each of the moving vectors on an image is a vector derived by connecting a position of an object in a photographic image photographed before moving with a position of the object in a photographic image photographed after moving.

Template matching, for example, may be used as a method of extracting picture elements of a same object. This is the same as the first embodiment. In a case where the template matching is used in the second embodiment, for example, a process is performed in which a portion of the photographic image of the subsequent frame is compared with a same portion of the photographic image of the previous frame set as a template, and the process is repeated for other portions of the photographic image until the entire photographic image is compared. Besides the template matching technique, a feature point matching method may be used. This is also the same as the first embodiment.

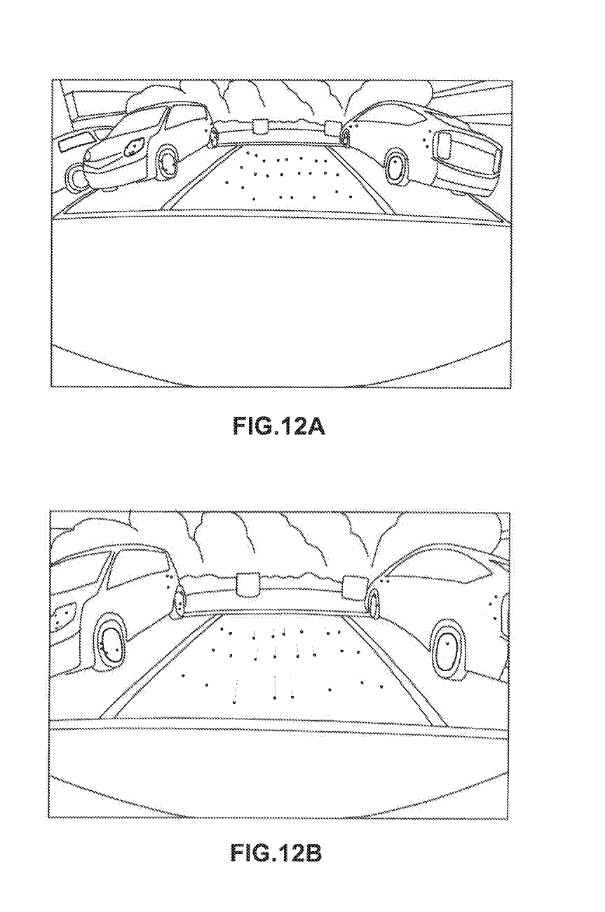

A method of deriving the moving vectors in the second embodiment is explained with reference to the drawings. FIGS. 12A and 12B illustrate the method of deriving the moving vectors by use of the feature point matching method. FIGS. 12A and 12B illustrate the photographic image of the previous frame and the photographic image of the subsequent frame, respectively.

As shown in FIGS. 12A and 12B, by associating feature points in one photographic image with feature points in another photographic image photographed at a different time point, positions of the feature points before moving and position of the feature points after moving are derived. FIG. 12B illustrates paths which the feature points have taken. In other words, the moving vector derivation part 26a derives vectors showing directions of the paths and magnitudes of the feature points, as the moving vectors on the image.

With reference back to FIG. 11, next, the image processor 26 performs the on-road-surface projection process (a step S202). The on-road-surface projection process is a process in which the on-road-surface projection part 26b derives the on-road-surface moving vectors, by projecting onto the road surface (in the world coordinate system) the moving vectors derived by the moving vector derivation part 26a.

As described above, the moving vectors derived by the moving vector derivation part 26a are the moving vectors on an image so that the moving vectors derived by the moving vector derivation part 26a cannot be used as the moving amount of the host vehicle. Therefore, the moving vectors on the image need to be converted into moving vectors on an actual road surface. In other words, in order to derive the actual moving amount corresponding to each of the moving vectors on the image, the on-road-surface projection part 26b derives the on-road-surface moving vectors by projecting onto the road surface the moving vectors on the image.

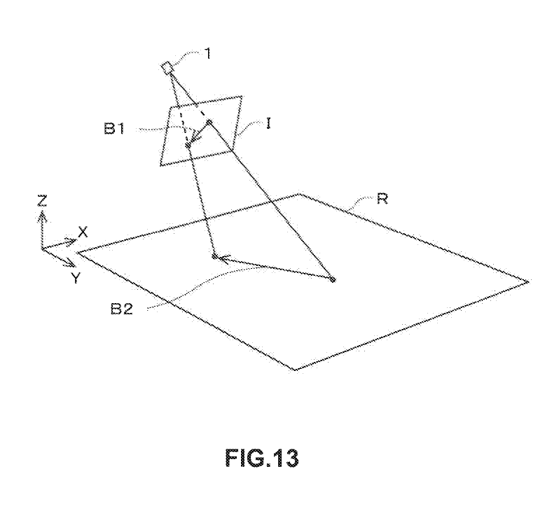

Here, the process of projecting the moving vectors onto the road surface is concretely explained with reference to the drawings. FIG. 13 illustrates an outline of a process of converting the moving vectors on the photographic image into the on-road-surface moving vectors.

As shown in FIG. 13, a moving vector B1 on a photographic image I photographed by the camera 1 is projected onto a road surface R and thus is converted into a moving vector B2 on the road surface R (hereinafter also referred to simply as “on-road-surface moving vector B2”). Concretely, a line generated by connecting a viewpoint of the camera 1 with an initial point of the moving vector B1 on the photographic image I is extended. The on-road-surface moving vector B2 starts from an initial point where the extended line intersects with the road surface R. Likewise, a line generated by connecting the viewpoint of the camera 1 with a terminal point of the moving vector B1 on the photographic image I is extended. The on-road-surface moving vector B2 ends at a terminal point where the extended line intersects with the road surface R. In FIG. 13, the photographic image I is a virtual image that is used for converting the moving vector B1 on the image into the on-road-surface moving vector B2 and is not an image that exists in an actual space.

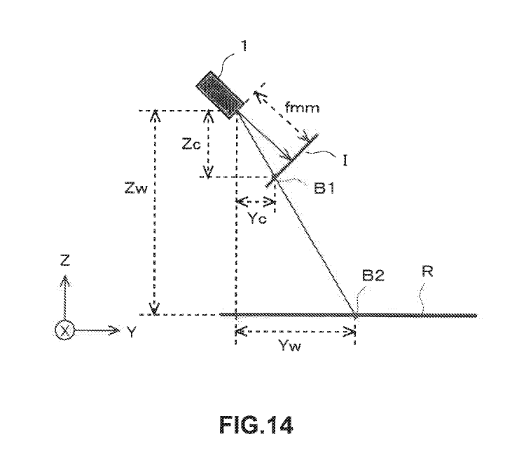

In a case where the road surface R is an X-Y plane and where a position of the camera 1 is a reference point, the initial point and the terminal point of the on-road-surface moving vector B2 can be derived from X-coordinate and Y-coordinate. A method of deriving the X-coordinate and the Y-coordinate is concretely explained with reference to the drawing. FIG. 14 illustrates the method of deriving a coordinate of the on-road-surface moving vectors.

FIG. 14 illustrates the moving vector B1 on the photographic image I projected onto the road surface R viewed on a Y-Z plane, i.e., viewed from an X-axis direction. Moreover, a distance fmm in FIG. 14 represents a focal length of the camera 1. A distance Zw represents a distance from a position of the viewpoint of the camera 1 and the road surface R in a Z-axis direction (height). Moreover, a distance Yc and a distance Zc represent a distance from the position of the viewpoint of the camera 1 to a position of the moving vector B1 in a Y-axis direction and a distance from the position of the viewpoint of the camera 1 to the position of the moving vector B1 in the Z-axis direction, respectively. Those values are defined by a specification (lens model and a focal length, etc.) of the camera 1 and an installation position and an installation angle of the camera 1 relative to the ground.

A Y-coordinate (Yw) of the on-road-surface moving vector B2 is derived by a formula below.

Yw=Zw/Zc×Yc

Likewise, an X-coordinate (Xw) of the on-road-surface moving vector B2 is derived by a formula below.

Xw=Zw/Zc×Xc

Xc represents a distance from the position of the viewpoint of the camera 1 to the moving vector B1 in the X-axis direction.

Thus, the X-coordinate and the Y-coordinate of the on-road-surface moving vector B2 are determined. Therefore, once the initial point and the terminal point of the on-road-surface moving vector B2 are derived, the on-road-surface moving vector B2 is derived.

With reference back to FIG. 11, next, the image processor 26 performs the moving amount derivation process (a step S203). The moving amount derivation process is a process in which the moving amount derivation part 26c derives the actual moving amount of the host vehicle, by using the on-road-surface moving vectors derived by the on-road-surface projection part 26b.

In many cases, the photographic image of the region near the host vehicle photographed by the camera 1 includes a portion showing the road surface and a portion showing a cubic object, such as a vehicle. Since the road surface is a plane and is not a moving object, moving vectors of the road surface have substantially a same magnitude in substantially a same direction. On the other hand, moving vectors of the cubic objects have different magnitudes in different directions, depending on moving directions and height of the cubic objects. Therefore, like in the first embodiment, the moving vectors of the road surface need to be extracted from the moving vectors to accurately derive the moving amount of the host vehicle.

Since the moving vectors relating to the road surface account for most of the derived moving vectors, also in the second embodiment, a histogram of magnitudes for all of the extracted moving vectors is generated and the moving vectors categorized in a range having a largest number of the moving vectors (peak in the histogram) are extracted as the moving vectors of the road surface, like in the first embodiment. Then, the moving amount derivation part 26c derives a magnitude of the extracted moving vectors of the road surface as the moving amount of the host vehicle. A method similar to the method explained in the first embodiment with reference to FIG. 9 may be used for deriving the moving vectors of the road surface by use of the histogram.

With reference back to FIG. 11, next, the moving amount derivation system 11 performs a predetermined display process, using the derived moving amount (a step S204). The moving amount derivation system 11 performs the display process, for example, of showing the guiding line as the future moving path. A method similar to the method explained in the first embodiment may be used for the display process in the second embodiment.

As described above in the second embodiment, the moving vectors on the photographic image photographed by the camera 1 are derived and then the derived moving vectors on the photographic image are converted into the on-road-surface moving vectors. As a result, it is possible to derive the moving amount of the host vehicle only by use of the photographic images, without generation of bird's-eye view images. Thus, in this embodiment, miniaturization and cost reduction can be realized. In addition, process load can be reduced and the moving amount can be derived accurately. Moreover, since the on-road-surface moving vectors corresponding to the moving vectors derived based on the photographic image are derived, it is possible to derive the moving vectors having magnitudes close to moving amounts in a real space.

### 3. Modifications

The embodiments of the invention have been described above. However, the invention is not limited to the foregoing embodiments, but various modifications are possible. Such modifications are described below. Any of forms in the foregoing embodiments and in the modifications below may be combined with another appropriately.

In the foregoing embodiments, when the moving vectors of the road surface are derived, a histogram of magnitudes is used. However, a method of deriving moving vectors is not limited to a histogram of magnitudes. For example, a histogram of directions may be used to derive the moving vectors of a road surface.

In other words, the moving vectors of the road surface account for most of a photographic image acquired by photographing a region near a host vehicle. The moving vectors of the road surface are substantially in a same direction. Therefore, it is possible to derive the moving vectors of the road surface by use of the histogram of directions.

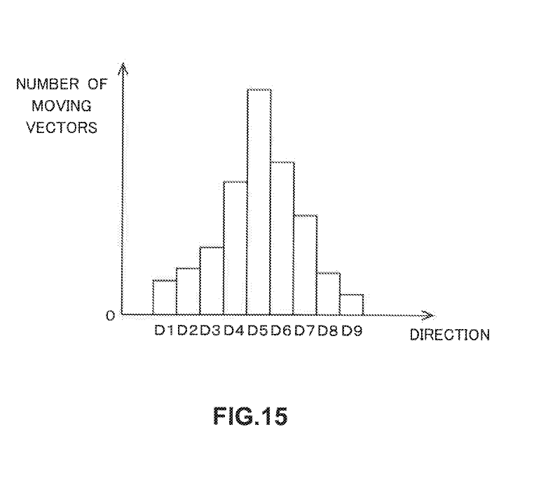

A method of deriving the moving vectors of the road surface by use of the histogram of directions is concretely explained with reference to FIG. 15. FIG. 15 illustrates an example of the histogram of directions for all of the moving vectors. The histogram in FIG. 15 illustrates the histogram showing all of the extracted moving vectors categorized and accumulated in nine angle ranges from D1 to D9, depending on a direction of the moving vector. As shown in FIG. 15, number of the moving vectors in the angle range D5 is the largest. Therefore, the moving vectors in the angle range D5 are extracted as the moving vectors of the road surface.

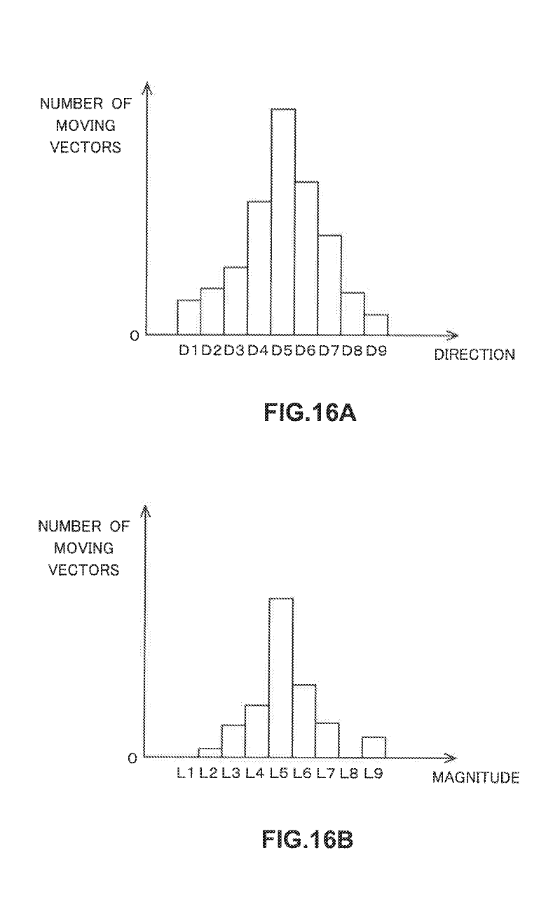

Moreover, two histograms of directions and of magnitudes may be used to derive moving vectors of a road surface. A method of deriving the moving vectors of the road surface by use of the histograms of directions and of magnitudes is concretely explained with reference to FIG. 16A and FIG. 16B. FIG. 16A illustrates an example of the histogram of directions of all moving vectors and is a same drawing as FIG. 15. In other words, in a method same as the method in FIG. 15, moving vectors in the angle range D5 are extracted. Thus, the moving vectors in a same direction are extracted.

However, the moving vectors in the same direction may include moving vectors of a cubic object of which directions are the same as a direction of the moving vectors of the road surface. Therefore, the moving vectors of the road surface are extracted from the moving vectors in the angle range D5, by use of the histogram of magnitudes. FIG. 16B illustrates an example of the histogram of magnitudes for the moving vectors, and the histogram shows the moving vectors in the angle range D5 categorized and accumulated in nine length ranges from L1 to L9, depending on lengths of the moving vectors. As shown in FIG. 16B, number of the moving vectors in the length range L5 is the largest. Therefore, the moving vectors in the length range L5 are extracted as the moving vectors of the road surface.

As described above, the moving vectors both in a magnitude range and a direction range having the largest number of the moving vectors are extracted, by use of the two histograms of directions and magnitudes. In other words, the moving vectors of the road surface can be derived accurately.

In the foregoing embodiment, the various functions are implemented by software using the CPU executing the arithmetic processing in accordance with the program. However, a part of the functions may be implemented by an electrical hardware circuit. Contrarily, a part of functions implemented by hardware may be implemented by software.

While the invention has been shown and described in detail, the foregoing description is in all aspects illustrative and not restrictive. It is therefore understood that numerous other modifications and variations can be devised without departing from the scope of the invention.

What is claimed is:

1. A moving amount derivation apparatus that derives a moving amount of a host apparatus that includes the moving amount derivation apparatus, the moving amount derivation apparatus comprising:
an image acquisition part that acquires a series of photographic images from a photographing apparatus that the host apparatus includes and that moves with the host apparatus; and
an image processor coupled to the image acquisition part, the image processor configured to:
(i) derive a moving vector of a photographed object within the series of the photographic images, using a plurality of the photographic images out of the series of the photographic images, the plurality of the photographic images having been photographed at different time points; and
(ii) derive the moving amount of the host apparatus based on the moving vector.

2. The moving amount derivation apparatus according to claim 1, wherein the image processor is further configured to:
generate a bird's-eye view image corresponding to any of the acquired photographic images; and
derive the moving vector based on the bird's-eye view images corresponding to the plurality of the photographic images photographed at the different time points.

3. The moving amount derivation apparatus according to claim 1, wherein
the image processor derives an on-road-surface moving vector corresponding to the moving vector derived based on the plurality of the photographic images which include a road surface as the photographed object.

4. The moving amount derivation apparatus according to claim 3, wherein
the image processor derives the on-road-surface moving vector by projecting, onto the road surface, the moving vector derived based on the plurality of the photographic images.

5. The moving amount derivation apparatus according to claim 1, wherein
the image processor extracts moving vectors of the road surface from the moving vectors derived based on the plurality of the photographic images.

6. The moving amount derivation apparatus according to claim 5, wherein
the image processor generates a histogram of magnitudes for the moving vectors derived based on the plurality of the photographic images and extracts the moving vectors in a magnitude having a largest number of the moving vectors as the moving vectors of the road surface.

7. The moving amount derivation apparatus according to claim 5, wherein
the image processor generates a histogram of directions for the moving vectors derived based on the plurality of the photographic images and extracts the moving vectors in a direction having a largest number of the moving vectors as the moving vectors of the road surface.

8. The moving amount derivation apparatus according to claim 1, wherein the image processor is further configured to (a) estimate a future moving path of the host apparatus based on the derived moving amount, and (b) generate a display image in which a guiding symbol that shows the future moving path is superimposed with any of the photographic images.

9. The moving amount derivation apparatus according to claim 8, wherein the guiding symbol is a guiding line.

10. A moving amount derivation method that derives a moving amount of a host apparatus, the moving amount derivation method comprising the following steps executed by an image processor:
(a) acquiring a series of photographic images from a photographing apparatus that the host apparatus includes and that moves with the host apparatus;
(b) deriving a moving vector of a photographed object within the series of the photographic images, using a plurality of the photographic images out of the series of the photographic images, the plurality of the photographic images having been photographed at different time points; and
(c) deriving the moving amount of the host apparatus based on the moving vector.

11. The method according to claim 10, further comprising:
generating a bird's-eye view image corresponding to any of the acquired photographic images,
wherein the step of deriving the moving vector uses the the bird's-eye view images corresponding to the plurality of the photographic images photographed at the different time points.

12. The method according to claim 10, wherein
the moving vector is an on-road-surface moving vector derived based on the plurality of the photographic images which include a road surface as the photographed object.

13. The method according to claim 12, wherein
the on-road-surface moving vector is derived by projecting, onto the road surface, the moving vector derived based on the plurality of the photographic images.

14. The method according to claim 10, wherein
moving vectors of the road surface are extracted from the moving vectors derived based on the plurality of the photographic images.

15. The method according to claim 14, wherein
a histogram of magnitudes for the moving vectors derived based on the plurality of the photographic images is generated, and
the moving vectors in a magnitude having a largest number of the moving vectors are extracted as the moving vectors of the road surface.

16. The method according to claim 14, wherein
a histogram of directions for the moving vectors derived based on the plurality of the photographic images is generated, and
the moving vectors in a direction having a largest number of the moving vectors are extracted as the moving vectors of the road surface.

17. The method according to claim 10, further comprising:
estimating a future moving path of the host apparatus based on the derived moving amount; and
generating a display image in which a guiding symbol that shows the future moving path is superimposed with any of the photographic images.

18. The method according to claim 17, wherein the guiding symbol is a guiding line.
